(19) United States
(12) Patent Application Publication
(10) Pub. No.: US 2025/0305963 A1
(43) Pub. Date: Oct. 2, 2025

(54) OPTICAL WAVEGUIDE SENSOR FOR DETECTING ARSENIC IONS AND METHOD OF FABRICATING THE SAME

(71) Applicant: Vulcan Photonics Sdn. Bhd., Kuala Lumpur (MY)

(72) Inventors: Farah Hidayah Binti Jamaludin, Johor (MY); Khong Nee Koo, Pulau Pinang (MY); Evianie Bingak Edward, Johor (MY); Mun Oon Fong, Pulai Pinang (MY)

(73) Assignee: Vulcan Photonics Sdn. Bhd., Kuala Lumpur (MY)

(21) Appl. No.: 18/707,727

(22) PCT Filed: Mar. 30, 2023
(86) PCT No.: PCT/MY2023/050020

§ 371 Date: May 6, 2024

(51) Int. Cl. G01N 21/77; G01N 21/41

(52) U.S. Cl. CPC G01N 21/7703; G01N 21/4133

(57) ABSTRACT

The present invention relates to a method for forming an optical waveguide sensor for detecting arsenic ions in an aqueous solution. The method comprising the steps of treating a substrate with solvents, coating the treated substrate surface with a crosslinking agent selected from a group comprising carboxylic acid functional group containing organic molecules for forming a crosslinked substrate surface, coating the crosslinked substrate surface with a ligand comprising an amine functional group and mercaptan functional group for forming a functionalized substrate surface containing a layer of ligand surface, and complexing the layer of ligand surface with a solution containing iron ions for forming a functionalized substrate surface containing layer of ligand surface containing iron ion cores that is capable of binding with arsenic ions in an aqueous solution. The present invention also relates to the optical waveguide sensor for detecting arsenic ions fabricated with the method of the present invention.

### FIELD OF INVENTION

The present invention generally relates to detection of arsenic (As) ions, and more particularly to an optical waveguide sensor and method for fabricating the optical waveguide sensor for detecting arsenic ions in an aqueous solution.

### BACKGROUND

Arsenic (As) is known as one of the most toxic elements to all life forms. Arsenite, As(III) and arsenate, As(V) ions are the most common arsenic compounds that can be found in the environment. Arsenic contamination in water for drinking, food preparation, and produce irrigation, for example, poses a significant health and environmental threat as it can cause skin damage, cancer, and even death in humans, as well as inhibit growth, photosynthesis, and reproduction in plants. Hence, detection and quantification of arsenic (As) ions such as the As(III) and As(V) ions are crucial for both human health and environmental protection.

Optical thin-film sensors have recently been used for detection of potentially hazardous chemical ions due to numerous advantages such as compact size, lightweight, inexpensive, fast response time and flexibility for in-situ or remote monitoring. Hazardous chemical ions such as arsenic ions can be detected through the thin-film coating of material that is selectively reactive to the arsenic ions.

U.S. patent publication No. U.S. Pat. No. 7,776,611 B2 relates to functionalized composite materials having selective absorption for specific analytes, methods for the preparation of such materials as films, and optical sensors employing such films for optical detection of analytes. Although the employment of thin-film coating has been disclosed, there is still a difficulty in forming a uniform layer of the thin-film coating in the sensing region of the optical sensor. Non-uniform coating layer often results in non-repeatability and non-reproducibility of the optical sensor.

Furthermore, the sensors and methods currently disclosed in the prior art for detecting arsenic ions typically involve the use of silylating agents that are prone to react with both the silicon or silica substrate surface of the sensor device, as well as with themselves, resulting in agglomeration that decreases surface uniformity. Commonly used ligands to capture metallic cations are unable to effectively detect As(III) and As(V) ions as the same are present in polluted water as an anion. Other than that, the currently available sensors are bulky, complicated and costly to fabricate. Therefore, the present invention aims to provide an improved optical waveguide sensor for detecting arsenic ions and method of fabricating the same that can overcome or mitigate at least some of the aforementioned problems of the prior art.

### SUMMARY

The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

In one aspect, the present invention provides a method for forming an optical waveguide sensor for detecting presence of arsenic ions in an aqueous solution, the method comprising the steps of treating a substrate surface by cleaning the substrate surface with one or more solvents for enabling coating of the treated surface with a crosslinking agent, the substrate being selected from a group comprising a silica or a silicon substrate; and coating the treated substrate surface with the crosslinking agent selected from a group comprising carboxylic acid functional group containing organic molecules for forming a crosslinked substrate surface.

The method of the present invention can be characterized by coating the crosslinked substrate surface with a ligand comprising an amine functional group and a mercaptan functional group for forming a functionalized substrate surface containing a layer of ligand surface; and complexing the layer of ligand surface with a solution containing iron ions for forming a functionalized substrate surface containing layer of ligand surface containing iron ion cores that is capable of binding with arsenic ions in an aqueous solution, thereby forming the optical waveguide sensor adapted to interact with a light wave passing through the optical waveguide sensor from an input and an aqueous solution containing arsenic ions, wherein, binding of the arsenic ions to the iron ion cores triggers a change in material optical refractive index of the ligand surface corresponding to absorption kinetics of the arsenic ions, consequently changing resonant wavelength of the light wave passing through the optical waveguide sensor and the aqueous solution containing the arsenic ions, whereby the resonant wavelength change is measurable to determine concentration of the arsenic ions in the aqueous solution.

Advantageously this allows the arsenic ions to be identified and quantified with consistency as the method ensures that the sensor surface is uniform.

Typically, the one or more solvents is selected from the group comprising deionized water, ethanol, acetone, isopropanol, or combination thereof.

Typically, the functionalized substrate surface containing the layer of ligand is cleaned with isopropanol and water prior to complexing the layer of ligand with the iron ions.

Typically, the silicon substrate is further treated by coating a layer of silicon dioxide on the silicon substrate surface, prior to cleaning the substrate surface.

Typically, the silicon substrate is coated with the crosslinking agent comprising di- or poly carboxylic acid molecules.

Typically, the di- or poly carboxylic acid molecules are selected from a group comprising malic acid, oxalic acid, glutaric acid, succinic acid, tannic acid or polyacrylic acid for forming the crosslinked substrate surface.

Typically, the di- or poly carboxylic acid molecules are coated to the substrate surface via esterification.

In another embodiment, the crosslinked substrate surface is coated with the ligand comprising amine and mercaptan functional groups via amine conjugation using 1-Ethyl-3-(3-dimethylaminopropyl)-carbodiimide) (EDC) and N-Hydroxysuccinimide (NHS).

Typically, the ligand is selected from a group comprising 6-Thioguanine complex, 6-Amino-2-mercaptobenzothiazole complex, 4-Amino-6-hydroxy-2-mercaptopyrimidine monohydrate complex, 5-Amino-1,3,4-thiadiazole-2-thiol complex, 4-Amino-3-hydrazino-5-mercapto-1,2,4-triazole complex, and Cysteamine hydrochloride complex.

Typically, the layer of ligand is complexed with iron ions by exposing the functionalized substrate surface containing the layer of ligand to a solution containing iron ions at room temperature.

Advantageously, the selected ligand complex with iron ions allows for high efficiency binding of As(III) and As(V).

In another, aspect, there is provided an optical waveguide sensor for detecting arsenic ions in aqueous solution comprising a substrate surface having a uniform thin layer of crosslinking agent and a ligand coupled thereto, the substrate being selected from a group comprising a silica or a silicon substrate. The optical waveguide sensor of the present invention can be characterized in that the substrate surface is coated with the crosslinking agent selected from a group comprising carboxylic acid functional group containing organic molecules; the substrate surface coated with the crosslinking agent is coated with the ligand comprising an amine group and a mercaptan group via amine conjugation and the ligand is complexed with iron ions to enable binding of the ligand with arsenic ions, wherein the arsenic specialized optical waveguide sensor adapted to interact with a light wave passing through the optical waveguide sensor from an input and an aqueous solution containing arsenic ions, whereby binding of the arsenic ions to the ligand complexed with iron ions triggers a change in material optical refractive index of the ligand surface corresponding to absorption kinetics of the arsenic ions, consequently changing resonant wavelength of the light wave passing through the optical waveguide sensor and the aqueous solution containing the arsenic ions, wherein the resonant wavelength change is measurable to determine concentration of the arsenic ions in the aqueous solution.

Typically, the carboxylic acid functional group containing organic molecules are coupled to the substrate through esterification for forming a crosslinked substrate surface, thereby enabling coating of the crosslinked substrate surface with the ligand for forming a functionalized substrate surface containing a layer of ligand surface.

Typically, the functionalized substrate surface containing a layer of ligand surface is exposed to iron ions to form the functionalized substrate surface containing a layer of ligand surface containing iron ion cores to enable binding of the iron ions cores to arsenic ions, thereby forming the optical waveguide sensor.

Advantageously, the method of the present invention avoids the use of silylating agents with iron (III) nitrate to couple the ligands onto the substrate surface, which result in a uniform thin film coating of ligand onto the substrate and therefore allowing for repeatability and reproducibility of the optical waveguide sensor. The present invention involves a layer-by-layer reaction whereby the substrate is first coated with carboxylic acid groups crosslinking agent and therefore only reacts with the silica present on the treated silicon or silica substrate via the Fischer esterification reaction, which thus eliminates the possibility of agglomeration and improves the surface uniformity. Furthermore, avoiding the use of silylating agents with iron (III) nitrate which produces iron oxide nanoparticles in solid form eliminates the requirement of high temperature for ligand sintering, therefore allowing ligand sintering at a low temperature for forming a stable ligand coating onto the substrate surface.

Advantageously, the coating of di- or poly carboxylic acid molecules results in a substrate surface with carboxylic acid groups, which provides possibilities for coupling with various ligands, resulting in tuneable sensitivity and concentration range of the waveguide sensor, as more binding sites on the sensor allows for more arsenic ions to bind onto the functionalized substrate to produce signal change in the sensor.

Advantageously, the sensitivity and detection range of the optical waveguide sensor can be tuned by modifying the crosslinkers and ligands used in forming the functionalized substrate. The Fisher esterification, amine conjugation and iron complexation increase the number of binding sites for coating ligands and complexes that are reactive to arsenic ions. These simple processes used for forming the functionalized substrate for selectively detecting arsenic ions may potentially ease mass production of the optical waveguide sensor.

### BRIEF DESCRIPTION OF DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 illustrates the methods of coupling a substrate of an optical waveguide sensor with selected crosslinkers and ligands according to the present invention.

FIG. 2 illustrates the examples of substrates coupled with selected ligands in use for detecting arsenic ions in an aqueous solution according to the present invention.

FIG. 3 illustrates an example of the waveguide sensor according to the present invention.

FIG. 4 illustrates an example of wavelength shift due to increased ions concentration according to the present invention.

FIG. 5 illustrates an example of the method for fabricating the optical wave guide having the functionalized substrate surface according to the present invention.

### DETAILED DESCRIPTION

Exemplary embodiments of the present invention will now be described in detail with reference to the annexed drawings. The following detailed description includes the preferred embodiments of the present invention and should be taken as examples, without limiting the scope of the invention.

The term crosslinkers (or crosslinking reagents) refers to molecules that contain two or more reactive ends capable or chemically attaching to specific functional groups (primary amines, sulfhydryls, etc.) on proteins or other molecules.

The term esterification, in particular, Fischer esterification, refers to an organic reaction employed to convert carboxylic acids in presence of excess alcohol and a strong acid catalyst to form an ester as the final product.

The term ligand refers to an ion or molecule that can donate a pair of electrons to a metal ion to form a coordination complex.

The present invention provides a method for forming an optical waveguide sensor for detecting presence of arsenic ions in an aqueous solution. The optical waveguide sensor mainly comprises a substrate coated with a crosslinker and a ligand, which is complexed with iron ions. In order to form the optical waveguide sensor, the substrate needs to be functionalized by coupling the substrate with the crosslinking agent via esterification and the ligand via amine conjugation.

Typically, the substrate is selected from a group comprising silica (SiO₂) or silicon (Si). In order to coat the substrate with the crosslinking agent, it is essential to first treat the substrate surface by cleaning the substrate surface with solvents such as acetone and isopropanol, in order to enable reaction on the substrate surface with the crosslinking agent. Additionally, if the silicon substrate is chosen, it is preferred for the silicon substrate to be pre-treated via surface passivation by coating a layer of silicon dioxide with thickness ranging from 20 to 100 nm, followed by cleaning the pre-treated silicon substrate with acetone and isopropanol. Alternatively, the substrate surface may also be treated by using other solvents such as deionized water and/or ethanol.

Next, the treated substrate is configured to be coated with the crosslinking agent selected from a group comprising carboxylic acid functional group such as di- or poly carboxylic acid molecules, for forming a uniform thin layer of crosslinker surface on the substrate surface, thereby forming the crosslinked substrate surface. The coating of the di- or poly carboxylic acid molecules crosslinker to the substrate surface is preferably done by Fisher esterification. The di- or poly carboxylic acid molecules usable as the crosslinking agent includes malic acid, oxalic acid, glutaric acid, succinic acid, tannic acid or polyacrylic acid. The crosslinking agent is coated to the substrate surface to increase the number of binding sites to facilitate coating of the ligand.

The crosslinked substrate surface is then coated with the ligand for forming a functionalized substrate surface containing a layer of ligand, the ligand of which can be selected from a group comprising both an amine group and a mercaptan group. The coating is performed via amine conjugation using 1-Ethyl-3-(3-dimethylaminopropyl)-carbodiimide) (EDC) and N-Hydroxysuccinimide (NHS) to bind the amine group to the binding sites available on the crosslinked substrate surface. The amine conjugation is preferably conducted at a temperature ranging from 4-30° C. without any metallic catalysts, in order to preserve the mercaptan functional group from degrading. The layer of ligand surface of the functionalized substrate surface is then exposed to a solution containing iron ions at room temperature to complex the layer of ligand surface with the iron ions, for forming a surface of iron ion cores on the functionalized substrate surface. Upon exposure to the iron ions, the mercaptan group (thiol, —SH) binds to the iron ions, thereby forming a functionalized substrate surface containing a layer of ligand surface that contains the iron ion cores. The iron ion cores are capable of binding with arsenic ions in any aqueous solution, which may induce change to the material optical refractive index of the layer of ligand containing the iron ion cores. Prior to exposing the functionalized substrate surface containing the layer of ligand to the iron ions, the functionalized substrate surface containing the layer of ligand is first cleaned with isopropanol and water.

Since Arsenite, As(III), and Arsenate, As(V), are present in polluted water as anions, the ligand used to capture metallic cations need to be complexed with the iron ions, to enable selective binding with the As(III) and As(V). Since As(III) and As(V) binds to iron oxide with high efficiency, iron ions is therefore advantageous to be complexed with the layer of ligand of the functionalized substrate surface to provide a core cation for binding with the As(III) and As(V).

The amine functional group and mercaptan functional group ligand of choice depends on the selected carboxylic acid functional group. For example, when malic acid crosslinking agent is used, an iron and 6-Thioguanine complex is preferably selected as the ligand. Among the other ligands with iron ion cores that are preferred can be selected from a group comprising, iron and 6-Amino-2-mercaptobenzothiazole complex, iron and 4-Amino-6-hydroxy-2-mercaptopyrimidine monohydrate complex, iron and 5-Amino-1,3,4-thiadiazole-2-thiol complex, iron and 4-Amino-3-hydrazino-5-mercapto-1,2,4-triazole complex, and iron and Cysteamine hydrochloride complex.

The arsenic ions can react with the molecules of the ligand for forming a coordination complex, which shall then induce a change in material optical refractive index of the ligand. When a laser is provided across the optical waveguide sensor, the change of the material optical refractive index will consequently shift the resonant wavelength of the laser, whereby the intensity of the change can then be measured to determine concentration of the arsenic ions in the aqueous solution. The change in material optical refractive index of the layer of ligand depends on the absorption kinetics of the arsenic ions.

The functionalized substrate surface containing the layer of ligand and iron ion cores, i.e., the optical waveguide sensor, is configured to be interactable with a light wave at an input of the optical waveguide sensor and the aqueous solution containing arsenic ions, when the aqueous solution is in contact with the functionalized substrate surface. Once the aqueous solution contacts the surface of the functionalized substrate, the arsenic ions in the aqueous solution forms a coordination complex with the iron ion cores of the functionalized substrate surface as a reaction, thereby binding the arsenic ions onto the surface of the functionalized substrate surface. The reaction changes the material optical refractive index of the functionalized substrate surface and the layer of ligand and iron ion cores, which then changes the resonant frequency of the light wave travelling on the functionalized substrate surface, depending on the concentration of the arsenic ions available in the aqueous solution. The changes in the resonant frequency of the light wave can then be measured by using a software, which then facilitates determination of concentration of arsenic ions contained in the aqueous solution.

The more carboxylic acid groups crosslinkers used to coat the substrate surface translates to increase of number of binding sites available for the ligands to bind to, thereby increasing the capability of the ligand to bind to the ions of interest. This in turn tunes the sensitivity and concentration range of the optical waveguide sensor, as increases in binding sites on the optical waveguide sensor will require more ions to bind with the ligands to produce any reaction, in comparison to the optical waveguide sensor with lesser binding sites, consequently making the optical waveguide sensor less sensitive while increasing the ion detection range. The esterification of the carboxylic acid functional group and the amine conjugation can be repeated multiple times on the substrate surface for increasing numbers of the plurality of binding sites on the functionalized substrate surface, thereby allowing tuning of selectivity and sensitivity of the optical waveguide sensor.

According to another aspect of the invention, there is provided an optical waveguide sensor for detecting arsenic ions in aqueous solution, whereby the optical waveguide sensor is fabricated by the method as described above. The optical waveguide sensor comprises a substrate surface selected from a group comprising silicon or silica, which is coated with a uniform thin layer of crosslinking agent, and ligand for forming a functionalized substrate surface. The substrate surface is coated with the crosslinking agent selected from a group comprising carboxylic acid functional group containing organic molecules via esterification to enable coating of the ligand. The substrate surface coated with the crosslinking agent is coated with the ligand comprising amine group or mercaptan group via amine conjugation and complexed with iron ions to enable binding of the ligand with arsenic ions, thereby forming a functionalized substrate surface containing a layer of ligand and iron ion cores, i.e., the optical waveguide sensor.

The optical waveguide sensor is adapted to interact with a light wave passing through the arsenic specialized optical waveguide sensor from an input and an aqueous solution containing arsenic ions, whereby, binding of the arsenic ions to the iron ion cores triggers a change in material optical refractive index of the ligand surface corresponding to absorption kinetics of the arsenic ions, consequently changing resonant wavelength of the light wave passing through the optical waveguide sensor and the aqueous solution containing the arsenic ions. The resonant wavelength change of the light wave can then be measured to determine concentration of the arsenic ions in the aqueous solution.

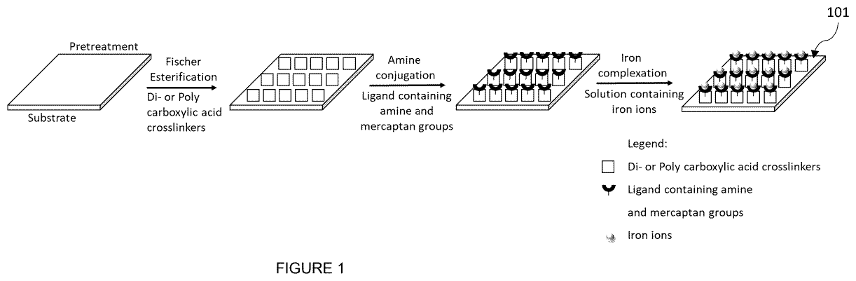

With the above description and as illustrated in FIG. 1, it can be understood that the arsenic ions can be detected by the optical waveguide sensor that employs the functionalized substrate surface 101. The sensitivity and detection range required by the optical waveguide sensor for detection of arsenic ions in the aqueous solution, such as arsenite, As(III), and arsenate, As(V) ions are tuneable. Once the aqueous solution is in contact with the ligands (the functionalized substrate surface 101 containing the layer of ligands and iron ion cores) of the optical waveguide sensor of the present invention, the arsenic ion then reacts with the surface of the ligands and binds onto the surface of the ligands. This then changes the material optical refractive index of the ligand, which changes correspond to absorption kinetics of the targeted ions and the ligands. The resonant wavelength of the light wave passing through the ligands will then changes, which can then be measured accordingly.

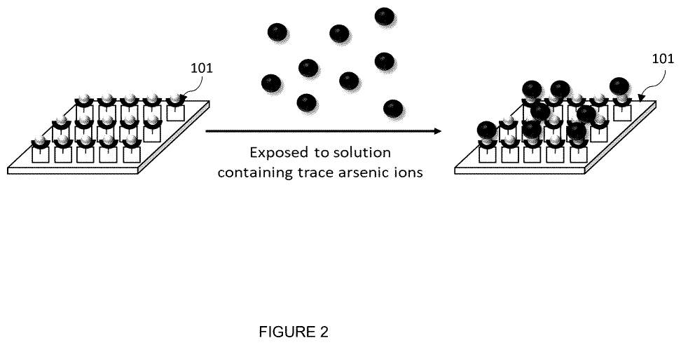

As illustrated in FIG. 2, the optical waveguide sensor detects presence of arsenic ions in an aqueous solution through the functionalized substrate surface 101 containing layer of ligand surface containing iron ion cores, which binds to the arsenic ions. This induces the change of absorption kinetics of the ligand, which then changes resonant wavelength of the laser passing through the optical waveguide sensor. The intensity of the resonant wavelength change can then be measured to determine the concentration of arsenic ions in the aqueous solution, by measuring the magnitude of the resonant wavelength shift, before and after the optical waveguide sensor is exposed to arsenic. The quantitative measurement of concentration of the ions can then be made with proper calibration data on an analytic software.

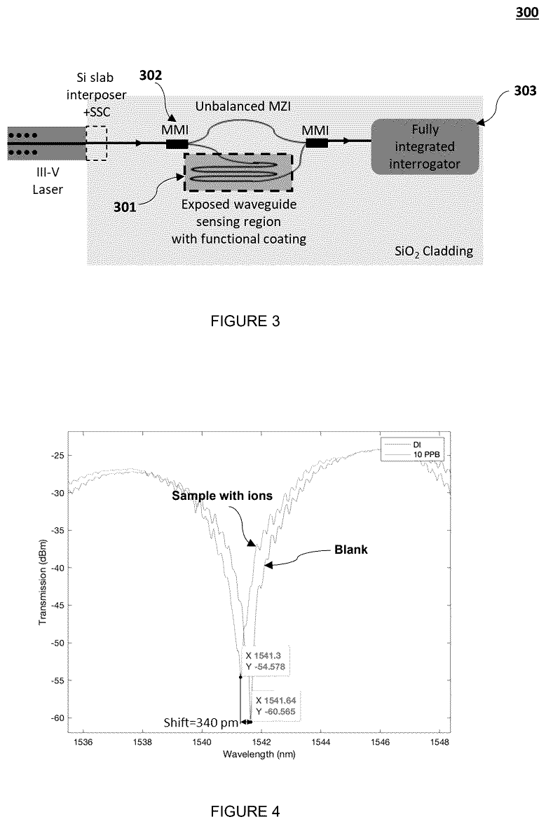

The functionalized substrate surface may be provided on a surface in a waveguide-based sensor comprising a chip with Mach-Zehnder interferometer (MZI) configuration. An example of a MZI optical waveguide sensor 300 with a silicon on insulator platform (SOI) comprising the functionalized substrate surface of the present invention is shown in FIG. 3. In this embodiment, the sensing region 301 comprises waveguides with a silicon dioxide SiO₂ cladding, having a thickness of about 20-100 nm, width 15-1000 nm and length about 200 μm-1 cm. The coupling is a vertical grating coupler 302, preferably in transverse mode. The wavelength range is 1500-1600 nm, with a resolution measurement up to 1 picometer (pm). An interrogator 303 is connected to an output, in which the interrogator 303 may comprise of a pair of MMI-based reflectors and two pairs of micro-ring resonators. Suitably, the readout parameter is in phase or lambda.

In use, the following sequence may be observed when a test is implemented with the MZI system. First, a drop of distilled water is added as a blank sample on the surface of the MZI system. Second, the droplet of distilled water is removed from the surface. Third, a drop of solution having a known concentration of arsenic ion is added on the surface. After 30 seconds to 2 minutes, the solution is removed from the surface. Then, a drop of distilled water is again added to the surface. Last but not least, the laser is swept from a wavelength of 1500 to 1600 nm, and the output of the sensor is measured.

As the functionalized substrate surface absorbs the ion, the change in the material index causes a shift in the wavelength, which facilitates in measuring or quantifying the arsenic ion concentration in the aqueous solution. The wavelength shifts as the functionalized substrate surface absorbs more arsenic ions from an aqueous solution. Accordingly, the sensor can be calibrated and optimized based on each different pair of channels having different characteristics to provide the greatest shift at a particular or selected wavelength. Advantageously, the comparison allows shifts of 340 pm to be measured accurately, corresponding to a sensitivity of 10 ppb arsenic ions. Example of wavelength shift caused by the change of material index of the functionalized substrate surface of the optical waveguide sensor is shown in FIG. 4. The presence of ions can be detected within a predetermined exposure time, for example within 20 to 120 seconds. It has been found that the change or wavelength shift does not substantially change further after 120 seconds.

The embodiment of the present invention will now be described with the following examples.

The examples provided herein are intended to illustrate the different aspects and embodiments of the invention. The examples are not intended in any way to limit the disclosed invention, which is limited only by the appended claims.

### EXAMPLE 1

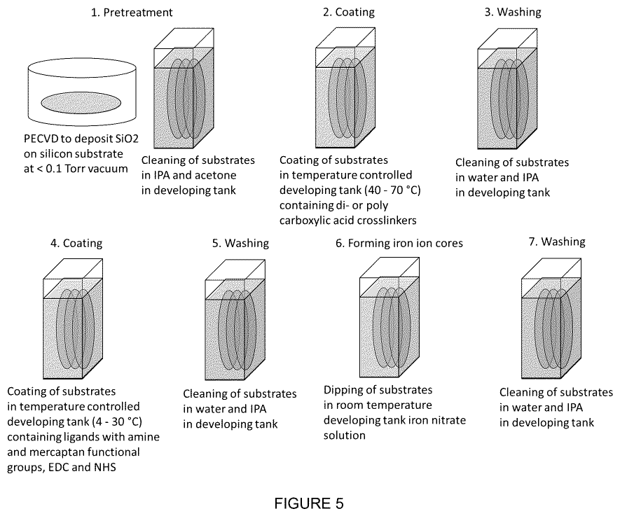

The method of fabricating the sensor involves plasma-enhanced chemical vapor deposition (PECVD) if the substrate selected is silicon at a room temperature and at vacuum pressure of less than 0.1 Torr. Subsequent steps are carried out in atmospheric pressure. For silica and silica coated silicon substrates, the substrates can be cleaned in developing tanks containing IPA and acetone. After which, coating of the di- or poly-carboxylic acid can be done by submerging the substrates in a temperature controlled (40-70° C.) developing tank containing the di- or poly-carboxylic acid. This step is then followed by a washing step to wash the substrates with water and IPA in separate developing tanks. Following which, the ligands which are amine and mercaptan functional groups containing molecules that can be coated by submerging the substrates in a temperature controlled (4-30° C.) developing tank containing the ligands. This step is then followed by a washing step to wash the substrates with water and IPA in separate developing tanks. After which, the iron ion cores that are selective to arsenic ions is formed by dipping the ligand containing substrates into a developing tank containing a solution of iron nitrate at room temperature. Finally, the substrates can be washed using water and IPA in separate developing tanks. The above process flow is as illustrated in FIG. 5.

### EXAMPLE 2

Table 1 shows a list of examples of possible configurations of the functionalized substrate 101 together with the crosslinkers and the ligands used for detecting the arsenic ions, according to an embodiment of the present invention.

TABLE 1
Types of ligands and the corresponding crosslinking agents,
suitable for use to detect arsenic (As(III) and As(V)) ions,
according to an embodiment of the present invention:

| | | Di- or poly-carboxylic |
|---|---|---|
| | Ligands | acid crosslinkers |
| Ligand | Iron and 6-Thioguanine complex | Malic acid |
| containing | Iron and 6-Amino-2- | Succinic acid |
| amine and | mercaptobenzothiazole complex | |
| mercaptan | Iron and | Glutaric acid |
| groups | 4-Amino-6-hydroxy-2- | |
| | mercaptopyrimidine monohydrate | |
| | complex | |
| | Iron and 5-Amino-1,3,4- | Oxalic acid |
| | thiadiazole-2-thiol complex | |
| | Iron and 4-Amino-3-hydrazino-5- | Tannic acid |
| | mercapto-1,2,4-triazole complex | |
| | Iron and Cysteamine | Poly acrylic acid |
| | hydrochloride complex | |

The above-described embodiments of a method to fabricate the optical waveguide sensor only utilizes non-toxic solvents such as water and ethanol. Therefore, the above-described fabrication process may potentially improve sustainability in producing the optical sensor, in comparison to the optical waveguide sensor fabricated with methods of the prior art. Further, the sensitivity of arsenic ions sensing of the optical waveguide sensor produced by the above-described method may be tuneable, thereby improving portability and simplicity with sensing the arsenic ions in water, in comparison to inductively coupled plasma atomic emission spectroscopy method, ICP-OES. Further, the method of the present invention improves scalability for mass production of the optical waveguide sensor of the present invention. This is made possible with the use of only two sets of equipment, mainly a PECVD chamber and a developer tank, resulting to a highly versatile method which could be easily performed in series and modified according to the required specifications of the sensor.

Next, the present invention does not require high temperature for fabrication purpose. The use of ligands complexed with iron ions, as an arsenic selective ligand, eliminates the need of processing the delicate substrate in high temperature upwards of 450° C. This high temperature sintering is required with the use of organosilicate silylating agents with iron (III) nitrate which would produce iron oxide nanoparticles in solid form that requires sintering at high temperature in order to form a stable coating on the targeted substrates. Also, the method of the present invention eliminates the use of silylating agents which are moisture and pH sensitive and requires more stringent process control and anhydrous solvent. For water soluble reactants, water can be used as the reaction medium which makes the process more environmentally friendly and less toxic and flammable. Further, the optical waveguide sensor of the present invention may utilize the unique absorption kinetics of arsenic on the ligands to give a quantitative result of the presence of arsenic ions in the solution, which facilitates analysis process. This is achievable through measurement of resonant wavelength shift of the laser that passes across the functionalized substrate surface of the optical waveguide sensor over time, which could then be deconvoluted via the computing medium, which can be a personal computer or a smart device such as smartphones.

While the invention has been described as required in terms in preferred embodiments and specific operating ranges and conditions, those skilled in the art will appreciate that the invention described herein is susceptible to variations and modifications other than those specifically described.

1. A method for forming an optical waveguide sensor for detecting presence of arsenic ions in an aqueous solution, the method comprising the steps of:
treating a substrate surface by cleaning the substrate surface with one or more solvents for enabling coating of the treated surface with a crosslinking agent, the substrate being selected from a group comprising a silica or a silicon substrate; and
coating the treated substrate surface with the crosslinking agent selected from a group comprising carboxylic acid functional group containing organic molecules for forming a crosslinked substrate surface,
characterized by:
coating the crosslinked substrate surface with a ligand comprising an amine functional group and a mercaptan functional group for forming a functionalized substrate surface containing a layer of ligand surface; and
complexing the layer of ligand surface with a solution containing iron ions for forming a functionalized substrate surface containing layer of ligand surface containing iron ion cores that is capable of binding with arsenic ions in an aqueous solution, thereby forming the optical waveguide sensor adapted to interact with a light wave passing through the optical waveguide sensor from an input and an aqueous solution containing arsenic ions,
wherein, binding of the arsenic ions to the iron ion cores triggers a change in material optical refractive index of the ligand surface corresponding to absorption kinetics of the arsenic ions, consequently changing resonant wavelength of the light wave passing through the optical waveguide sensor and the aqueous solution containing the arsenic ions, whereby the resonant wavelength change is measurable to determine concentration of the arsenic ions in the aqueous solution.

2. The method according to claim 1, wherein the one or more solvents is selected from the group comprising deionized water, ethanol, acetone, isopropanol, or combination thereof.

3. The method according to claim 2, wherein the functionalized substrate surface containing the layer of ligand is cleaned with isopropanol and water prior to complexing the layer of ligand with the iron ions.

4. The method according to claim 1, wherein the silicon substrate is further treated by coating a layer of silicon dioxide on the silicon substrate surface, prior to cleaning the substrate surface.

5. The method according to claim 1, wherein the silicon substrate is coated with the crosslinking agent comprising di- or poly carboxylic acid molecules.

6. The method according to claim 5, wherein the di- or poly carboxylic acid molecules are selected from a group comprising malic acid, oxalic acid, glutaric acid, succinic acid, tannic acid or polyacrylic acid for forming the crosslinked substrate surface.

7. The method according to claim 6, wherein the di- or poly carboxylic acid molecules are coated to the substrate surface via esterification.

8. The method according to claim 1, wherein the crosslinked substrate surface is coated with the ligand comprising amine functional group and mercaptan functional group via amine conjugation using 1-Ethyl-3-(3-dimethylaminopropyl)-carbodiimide) (EDC) and N-Hydroxysuccinimide (NHS).

9. The method according to claim 8, wherein the ligand is selected from a group comprising 6-Thioguanine complex, 6-Amino-2-mercaptobenzothiazole complex, 4-Amino-6-hydroxy-2-mercaptopyrimidine monohydrate complex, 5-Amino-1,3,4-thiadiazole-2-thiol complex, 4-Amino-3-hydrazino-5-mercapto-1,2,4-triazole complex, and Cysteamine hydrochloride complex.

10. The method according to claim 1, wherein the layer of ligand is complexed with iron ions by exposing the functionalized substrate surface containing the layer of ligand to a solution containing iron ions at room temperature.

11. An optical waveguide sensor for detecting arsenic ions in aqueous solution comprising:
a substrate surface having a uniform thin layer of crosslinking agent and a ligand coupled thereto, the substrate being selected from a group comprising a silica or a silicon substrate; characterized in that,
the substrate surface is coated with the crosslinking agent selected from a group comprising carboxylic acid functional group containing organic molecules;
the substrate surface coated with the crosslinking agent is coated with the ligand comprising an amine group and a mercaptan group via amine conjugation and the ligand is complexed with iron ions to enable binding of the ligand with arsenic ions,
wherein the optical waveguide sensor adapted to interact with a light wave passing through the optical waveguide sensor from an input and an aqueous solution containing arsenic ions,
whereby binding of the arsenic ions to the ligand complexed with iron ions triggers a change in material optical refractive index of the ligand surface corresponding to absorption kinetics of the arsenic ions, consequently changing resonant wavelength of the light wave passing through the optical waveguide sensor and the aqueous solution containing the arsenic ions,
wherein the resonant wavelength change is measurable to determine concentration of the arsenic ions in the aqueous solution.

12. The sensor according to claim 11, wherein the carboxylic acid functional group containing organic molecules are coupled to the substrate through esterification for forming a crosslinked substrate surface, thereby enabling coating of the crosslinked substrate surface with the ligand for forming a functionalized substrate surface containing a layer of ligand surface.

13. The sensor according to claim 12, wherein the functionalized substrate surface containing a layer of ligand surface is exposed to iron ions to form the functionalized substrate surface containing a layer of ligand surface containing iron ion cores to enable binding of the iron ions cores to arsenic ions, thereby forming the optical waveguide sensor.
